(19) United States
(12) Patent Application Publication
(10) Pub. No.: US 2008/0260905 A1
(43) Pub. Date: Oct. 23, 2008

(54) Dairy Product and Process

(75) Inventors: Stephen Gregory, Palmerston North (NZ); Vaughan Crow, Palmerston North (NZ); Rachel Marshall, Springfield, MO (US)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 11/571,823

(22) PCT Filed: Jul. 8, 2005
(86) PCT No.: PCT/NZ2005/000165

§ 371 Date: Apr. 2, 2008

(30) Foreign Application Priority Data
Jul. 9, 2004 (NZ) 534008

(51) Int. Cl. A23C 19/00; A23C 9/12; A23L 1/22; A23C 9/156

(52) U.S. Cl. 426/35; 426/582; 426/580; 426/570

(57) ABSTRACT

The present invention is directed to a process for producing a dairy flavour ingredient, with an intense dairy flavour and low pH especially suitable for flavouring dairy products which are produced by “rapid” dairy technologies. The process includes blending a dairy based protein with an acid producing producing bacteria, fermenting at ph<5.5, further blending with ground cheese, further fermentation with and enzyme and heat inactivating the enzyme.

### FIELD OF THE INVENTION

The present invention relates to a dairy flavour ingredient and a method of manufacturing same. The flavour ingredient is particularly, although not exclusively, useful in flavouring dairy products which are made using non-conventional methods.

### BACKGROUND

It is increasingly common in the dairy industry to produce dairy products including hard, soft or semi-soft cheese, yoghurt, mousse dessert, dairy dips, dressings etc by simply mixing together raw ingredients and heating to form an emulsion or gel without the need for fermentation or enzymatic treatments (U.S. Pat. No. 6,177,118; WO 02/080691; WO 03/051130; U.S. Pat. No. 6,406,736; U.S. Pat. No. 5,750,177; for example). Such methods are rapid, efficient, less labour intensive and less costly than conventional methods, particularly conventional cheese making methods. However, dairy products produced by these “rapid” processes are generally bland in flavour as they have by-passed the conventional flavour development steps associated with fermentation and enzymatic treatments. This is a particular problem with cheese made by the “rapid” processes as cheese flavours usually take months, and sometimes years, to develop. One solution has been to use enzyme modified cheese (EMC) as an intense flavour additive. An EMC flavour ingredient is generally prepared by adding selected enzymes (proteases, lipases etc) to a cheese curd that is typically slurried with water. Intense flavours develop over a period of hours to days (Kilkowley et al, 1998; U.S. Pat. No. 3,765,905; WO 99/63834; U.S. Pat. No. 5,455,031; EP 1 053 689). However, such EMC flavour ingredients produced by these processes tend to lack the balanced flavour profile of a dairy product, particularly a cheese, that has been allowed to develop flavour conventionally. In addition, to produce a product having the correct moisture content, texture and flavour profile of a corresponding “natural” dairy product, the amount of water used in such “rapid” processes must be strictly controlled. This is mainly achieved by balancing the amount of water in the starting ingredients and the amount of water added during the process to flavour and acidify the dairy product.

It is an object of the present invention to produce a flavour ingredient that is useful for flavouring dairy products produced by “rapid” processes and/or to at least provide the public with a useful choice.

### SUMMARY OF THE INVENTION

The present invention may be said broadly to consist in a process for producing a dairy flavour ingredient comprising the steps:
(a) providing a dairy based protein composition having a solids content of 10-40% w/w;
(b) incubating with acid producing bacteria under conditions to reduce the pH of the composition to below 5.5, preferably below 5.0, and most preferably to between 3.0 and 4.0;
(c) adding ground cheese to give a solids content of 20-70% w/w (preferably 40-70% w/w) and blending to a slurry;
(d) incubating with at least one enzyme selected from a protease, peptidase and lipase under conditions to achieve the desired flavour intensity and/or flavour profile to produce a dairy flavour ingredient;
(e) heating to inactivate the enzyme; and
(f) optionally drying the dairy flavour ingredient.

The dairy based protein composition may comprise a milk or milk product selected from one or more of the group consisting of pasteurised or unpasteurised whole milk, skim milk, reduced fat milk, fat enhanced milk, butter milk, milk ultrafiltrate retentates, milk concentrates or isolates, powdered milks including powdered whole, reduced fat or skim milk and powdered butter milk, wherein the milk or milk product is sourced from any milk producing animal or analogue milk, or a combination thereof. Preferably, the dairy based protein composition comprises reconstituted milk protein concentrate (MPC), skim milk powder (SMP), butter milk powder (BMP), whole milk powder (WMP), or a combination thereof.

The present invention also provides a dairy flavour ingredient having a moisture content of 30-80% w/w; a solids content of 20-70% w/w; and a pH of less than 5.5, preferably less than 5.0. Most preferably the dairy flavour ingredient is characterised by having a moisture content of 30-60% w/w; a solids content of 40-70% w/w and a pH of between 3.0 and 4.0.

The dairy flavour ingredient may be prepared by the inventive process.

The present invention is also directed to dairy products such as hard, semi-soft or soft cheese, yoghurt, mousse, dessert, dairy dips, dressings etc containing the flavour ingredient of the invention.

Preferably the flavoured dairy product is a cheese or cheese-like product selected from the group comprising Cheddar, Cheddar-like cheese, Parmesan, Parmesan-like cheese, Edam, Edam-like cheese, Gouda, Gouda-like cheese or any other hard cheese in a solid block or crumble form.

The present invention is also directed to a use of the dairy flavour ingredient of the invention in the manufacture of a flavoured dairy product.

In a further embodiment, the present invention is directed to a process for producing a flavoured dairy product comprising the steps:

1. providing a dairy based protein composition; and
2. cooking to form a dairy product;
wherein the flavour ingredient of the present invention is added either before or during the cooking step to produce a dairy product having the flavour profile of an equivalent dairy product made by conventional processes.

Preferably, the process is carried out under conditions as disclosed in U.S. Pat. No. 6,177,118, WO 02/080691, WO 03/051130; U.S. Pat. No. 6,406,736; or U.S. Pat. No. 5,750,177, for example.

The invention is further directed to a flavoured dairy product made by this process. The dairy product may include a hard, semi-soft or soft cheese, yoghurt, mousse, dessert, dairy dip, dressing, sauce etc.

Preferably the flavoured dairy product is a cheese or cheese-like product selected from the group comprising Cheddar, Cheddar-like cheese, Parmesan, Parmesan-like cheese, Edam, Edam-like cheese, Gouda, Gouda-like cheese or any other hard cheese in a solid block or crumble form.

The present invention will now be described with reference to the accompanying drawings in which:

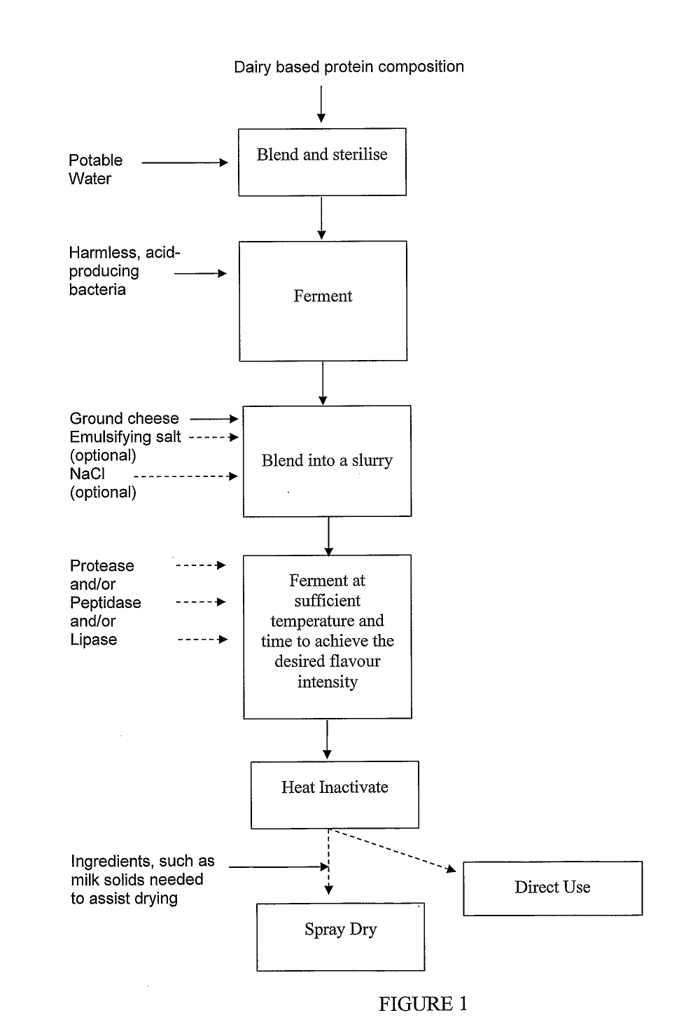

FIG. 1 shows a flow diagram of a first process embodiment of the present invention.

### DETAILED DESCRIPTION OF THE INVENTION

The present invention is directed to a process for producing a dairy flavour ingredient which can be used to flavour dairy products produced by “rapid” dairy technologies to produce a dairy product having the flavour profile of a corresponding “natural” dairy product.

The process broadly comprises providing one or more dairy based protein compositions having a solids content of between 10-40% w/w and incubating with acid producing bacteria which under suitable conditions reduce the pH of the composition to below 5.5, preferably to below 5.0, and most preferably to between 3.0 and 4.0. Ground cheese is then added to this acidic dairy based protein composition and the mixture blended to produce a slurry. Enzymes selected from lipases, proteases and/or peptidases are added to the slurry which break down the protein and/or fat in the composition and intense flavours develop. The enzymes are incubated under conditions of time and temperature suitable to achieve the desired flavour intensity and/or flavour profile. However, the pH of the slurry remains unchanged at below 5.5. Once the desired flavour profile is achieved, the composition is heated to inactivate the enzymes. The resulting dairy flavour ingredient has a moisture content of 30-80% w/w, preferably 30-60% w/w and a pH of below 5.5, preferably below 5.0 and may be used immediately or stored before use. Optionally, the flavour ingredient is dried or further concentrated before use. The process steps are set out in the flow diagram in FIG. 1.

This flavour ingredient has two important characteristics. Firstly, it has intense dairy flavour, and secondly, it has low pH (less than 5.5). These unique characteristics make this flavour ingredient highly suitable for flavouring dairy products which are produced by “rapid” dairy technologies.

It is known that in “rapid” dairy processes, the amount of water in the system must be strictly monitored to produce an end dairy product having the correct moisture content, texture and flavour profile of a corresponding “natural” dairy product. Such rapid processes further involve emulsion or gel formation in which water content is critical. It is usually prior to or during emulsion or gel formation that flavour agents including salt, food grade acids, EMC, enzymes and other GRAS flavours are added. The amount of flavour agent added needs to be balanced in terms of its moisture content and the overall moisture content of the system. For example, if food grade acid is to be added to both acidify and flavour the dairy product, an adjustment in moisture content of the composition must be made at another step in the process. This can be achieved by adding more solids (such as protein or fat) or starting out with a more concentrated dairy based protein substrate. However, for dairy products having a relatively low moisture content, such as a hard cheese, it is difficult to make such large adjustments in moisture content so that the use of standard flavour ingredients such as EMC and food grade acid (which have relatively high moisture content) is limited in such applications. Examples of such “rapid” dairy processes include U.S. Pat. No. 6,177,118, WO 02/080691, WO 03/051130, U.S. Pat. No. 6,406,736, and U.S. Pat. No. 5,750,177.

The dairy flavour ingredient of the present invention has an advantage over known flavour ingredients such as EMC in that it has equal or more intense flavour but has a low pH. Thus the flavour ingredient of the present invention has the dual purpose of both flavouring and acidifying the dairy product which has the benefit of minimising the impact, in terms of moisture content, on a dairy product made by a “rapid” dairy process.

Another advantage of the flavour ingredient of the present invention is that it avoids the need to use concentrated “synthetic” flavouring agents or concentrated acids so that the end dairy product comprises only “natural” ingredients.

Preferably the dairy based protein composition used in the process of the present invention is a milk or milk product selected from one or more of the group consisting of pasteurised or unpasteurised whole milk, skim milk, reduced fat milk, fat enhanced milk, butter milk, milk ultrafiltrate retentates, milk concentrates or isolates, powdered milks including powdered whole, reduced fat or skim milk and powdered butter milk, wherein the milk or milk product is sourced from any milk producing animal or analogue milk.

Most preferably the dairy based protein composition is milk protein concentrate (MPC) or skim milk powder (SMP) which is reconstituted with water to give a solid:water ratio of between 9:1 and 6:4 (i.e., a water content of 40-90% w/w).

Salt, and any other desired GRAS ingredient, may also be added to the dairy based protein composition depending upon the desired characteristics of the end product.

The dairy based protein composition is incubated with acid producing bacteria selected from a mesophilic or thermophilic starter cultures or a combination thereof. Examples of starter cultures including Streptococcus thermophilus, Lactobacillus bulgaricus, Lactobacillus helieticus, Lactobacillus lactis subspecies cremoris, Lactobacillus lactis subspecies lactis, Lactobacillus delbrueckii subspecies bulgaricus, and Lactococcus lactis subspecies biovar diacetylactis.

The starter culture may be added to the dairy based protein composition at 0.1-6.0% of the volume of the composition. The composition is then heated to a suitable temperature (30-45° C.) depending on the starter culture used and left for a sufficient time to reduce the pH of the composition to below 5.5, preferably below 5.0, and most preferably to between 3.0-4.0.

Ground cheese, including cheese curd, ripened cheese or mature cheese, is then added to the acidic composition to give a total solids content of the composition of 20-70% w/w. The type of cheese solids used will have a considerable effect on the final flavour profile as would be understood by a skilled worker.

One or more enzymes, selected from a protease, peptidase and lipase or combination thereof, are added to the composition and incubated under conditions of temperature and time sufficient to achieve the desired flavour intensity and/or flavour profile of the end product. The proteases and lipases are selected from any of the commercially available enzymes used commonly in the preparation of EMC ingredients.

Examples of suitable protease enzymes include Protease 2A “Amano” (Amano Enzymes) and Neutrase (Novo Nordisk); examples of suitable peptidase enzymes include Flavorpro (Biocatalyst), Promod (Biocatalysts), Savorase and Accelase; and an example of a suitable lipase enzyme is Kid Lamb Lipase 57, or palatase.

The amount of enzyme added is dependent on the amount of substrate present in the composition as well as the specific enzyme(s) used and is generally added in amounts recommended by the manufacturer.

The proteolysis and/or lipolysis is carried out at a temperature range of 20-60° C., preferably 40-50° C., most preferably 43° C. for 2 to 48 hours, preferably 10-30 hours.

The pH of the composition containing enzymes (or reaction mixture) is not altered and will be below 5.5, preferably, below 5.0, and most preferably between 3.0 and 4.0. It was surprising that the enzyme hydrolysis step, which uses commercially available enzymes used in standard EMC processes, could tolerate such low pH levels. Traditionally, EMC processes are carried out at a pH above 5.5, preferably around pH 6.5.

The hydrolysis step is terminated by heating the reaction mixture to 80-100° C. for 3 to 30 minutes, preferably by heating to about 90° C. for about 15 minutes to inactivate the enzymes.

The effect of enzyme addition in this hydrolysis step is to break down the protein and/or fat in the cheese substrate to create intense flavours. The flavour ingredient will have a mixture of concentrated flavours (derived chiefly from the product of amino acid fermentation). The type of enzyme(s) selected will determine the final flavour as will be appreciated by a skilled worker.

The initial starter culture selected may also impact on the final flavour profile as will be appreciated by a skilled worker.

The dairy flavour ingredient which is produced by the inventive process may be stored or used immediately to flavour a dairy product or may be dried or further concentrated using standard drying techniques such as spray drying or thin film evaporation, before use.

The present invention is also directed to the dairy flavour ingredient produced by the process of the present invention as well as to a dairy food product which has been flavoured by the dairy flavour ingredient of the present invention. Preferably, such a food product is selected from the group comprising natural cheese, including a natural hard, semi-soft or soft cheese, analogue cheese, foods comprising natural or analogue cheese, yoghurt, mousse, dessert, dairy dip, dressing, sauce, snack, biscuit, soup, pizza and other savoury flavour foods.

Most preferably, the dairy food product comprises a “natural” cheese or cheese-like product selected from Cheddar or Cheddar-like cheese, Parmesan or Parmesan-like cheese, Gouda or Gouda-like cheese, Edam or Edam-like cheese or any other hard cheese in a solid block or crumble form.

The dairy flavour ingredient of the present invention may also be used to flavour a processed-type dairy product, i.e. one that has had emulsification salts added during its production.

The invention also provides a dairy flavour ingredient having a moisture content of 30-80% w/w; a solids content of 20-70% w/w and a pH of less than 5.5, preferably less than 5.0. More preferably, the dairy flavour ingredient has a moisture content of 30-60% w/w, a solids content of 40-60% and a pH of 3.0-4.0. The dairy flavour ingredient has a concentrated savoury flavour profile produced by fermentation of dairy protein with at least one protease, peptidase or lipase. The dairy protein comprises a milk or milk product selected from one or more of the group consisting of pasteurised or unpasteurised whole milk, skim milk, reduced fat milk, fat enhanced milk, butter milk, milk ultrafiltrate retentates, milk concentrates or isolates, powdered milks including powdered whole, reduced fat or skim milk and powdered butter milk, wherein the milk or milk product is sourced from any milk producing animal or analogue milk, in combination with grated cheese.

As discussed above, the dairy flavour ingredient of the present invention is particularly suitable for dairy products which have been made by “rapid” dairy technologies. However, it is contemplated that this flavour ingredient may also be useful to flavour dairy products made by conventional processes as well as foods requiring a cheese like flavour such as pizzas, biscuits, snack, soups etc.

The present invention also provides a use of the dairy flavour ingredient of the present invention in the manufacture of a flavoured dairy product. Such a use involves adding the dairy flavour ingredient of the invention at a suitable step in a dairy process in place of, or in addition to, other flavour ingredients.

The present invention is also directed to a process of making a flavoured dairy product comprising the steps of:

1. providing a dairy based protein composition; and
2. cooking to form a dairy product,
wherein an amount of dairy flavour ingredient according to the present invention is added before or during the cooking step to produce a dairy product having the flavour profile which is comparable to an equivalent dairy product made by a conventional process.

This process is carried out under conditions as described in U.S. Pat. No. 6,177,118, WO 02/080691, WO 03/051130, U.S. Pat. No. 6,406,736 or U.S. Pat. No. 5,750,177, for example.

The flavour ingredient can be used in a range of food applications either on its own or in combination with other flavouring agents. In general terms the flavour ingredient is diluted sufficiently to provide flavour balance and enhance the impact of other flavour components. In most applications the flavour ingredient is used in the range of 0.1% to 10%. It may be used to enhance the flavour of natural cheese, processed cheese and analogue cheese foods. It can be used in sauces and dips, for example in a fondue recipe (14% Cheddar cheese, 23% cream, 47% milk, 9% butter, 4% flour, 2% other flavours) and 1% addition of the flavour ingredient improves the savoury and cheesy taste. It can be used in other foods requiring a cheese like flavour component such as snacks, biscuits, soups, pizza or other cheese or savoury flavoured food.

The invention is also directed to a food product produced by this process including a hard, semi-soft or soft cheese, yoghurt, mousse, dessert, dairy dip, dressing, sauce, snack, biscuit, soup, pizza and other savoury flavoured foods.

The term “comprising” as used in this specification and claims means “consisting at least in part of”, that is to say when interpreting independent claims, including that term, the features: prefaced by that term in each claim all need to be present by other features are also less present.

Any ranges mentioned in this patent specification are intended to inherently include all of the possible values within the stated range.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### EXAMPLE 1

1.3 kg of SMP was added to 11.7 litres of water in a Starter Pot and the milk composition sterilised at 90-95° C. for 90 minutes. The milk composition was then cooled to 42° C. and starter culture comprising Lactobacillus helviticus added and the composition mixed and allowed to ferment for 16 hours at 42° C., until the pH level dropped to below pH 4.

2.7 kg of the acidified composition was transferred to an EMC reactor. Ground Cheddar K Cheese (3.21 kg) and Granular K Cheese (3.21 kg) were then added to the acidified composition and the mixture gently agitated. The temperature was maintained at 42-43° C.

0.4 kg of water was used to dissolve 0.02 kg Savorase RST 100 (Rhodia), 0.0043 kg Neutrase (Novo), 0.0057 kg Protease 2A (Amano) and 0.007 kg Flavorpro 192 (Biocatalysts) before the enzyme mixture was added to the EMC reactor together with 0.115 kg of salt (NaCl). A further 0.5 kg of acidified composition was used to rinse the enzyme container and added to the reactor.

The mixture in the reactor was agitated to obtain a smooth slurry and agitation reduced for the next hour as a thin free fat layer developed. After 1 hour, 0.09 kg Hansen's Kid Lamb Lipase 57 was mixed into the free fat layer. After a further 24 hours incubation at 43° C., the mixture was heated to 90° C. for 15 minutes to inactivate the enzymes.

The characteristics of the final dairy flavour ingredient were as follows:
Moisture content: 53.7% w/w
pH: 4.3
Flavour Profile Intense, cheesy, Cheddar-like flavour with moderate butyric notes and acid bite.

### EXAMPLE 2

1.3 kg of SMP was added to 11.7 litres of water in a Starter Pot and the milk composition sterilised at 90-95° C. for 90 minutes. The milk composition was then cooled to 42° C. and starter culture comprising Lactobacillus helviticus added and the composition mixed and allowed to ferment for 16 hours at 42° C., until the pH level dropped to below pH 4.

2.7 kg of the acidified composition was added to an EMC reactor. Granular K Cheese (6.55 kg) was then added to the acidic composition and the mixture gently agitated. The temperature was maintained at 42-43° C.

0.4 kg of water was used to dissolve 0.0036 kg Neutrase (Novo), 0.0048 kg Protease 2A (Amano) and 0.0053 kg Flavorpro 192 (Biocatalysts) before the enzyme mixture was added to the reactor together with 0.115 kg salt (NaCl). A further 0.5 kg of acidified composition was used to rinse the enzyme container and added to the reactor.

The mixture in the reactor was agitated to produce a smooth slurry and agitation reduced over the next hour as a thin free fat film developed. After 1 hour, 0.02 kg Hansen's Kid Lamb Lipase 57 was mixed into the free fat layer. After a further 24 hours incubation at 43° C. the composition was heated to 90° C. for 15 minutes to deactivate the enzymes.

The characteristics of the final dairy flavour ingredient were as follows:
moisture content: 55.8% w/w;
pH: 4.5
Flavour Profile Intense, cheesy, Cheddar-like flavour with strong butyric notes and acid bite.

### EXAMPLE 3

3.9 kg of wholemilk powder (WMP) was added to 9.1 kg of water in a Starter Pot and the milk composition sterilised at 90-95° C. for 90 minutes. The milk composition was then cooled to 42° C. and starter culture comprising Lactococcus lactis subsp. lactis biovar. diacetylactis added and the milk composition mixed and allowed to ferment for ˜40 hours at 42° C., until the pH level dropped to 5.1.

1.3 kg of buttermilk powder (BMP) was added to 11.7 litres of water in a Starter Pot and the buttermilk composition sterilised at 90-95° C. for 90 minutes. The buttermilk composition was then cooled to 42° C. and starter culture comprising Lactobacillus helviticus added and the buttermilk composition mixed and allowed to ferment for 16 hours at 42° C., until the pH level dropped to 3.4.

1.28 kg of the acidified buttermilk composition was blended with 1.92 kg of the acidified milk composition.

2.7 kg of the blended acidified composition was added to an EMC reactor. 4.23 kg of ground Cheddar cheese was then added to the acidic composition, along with 220 g of disodium phosphate, and the mixture gently agitated. The temperature was maintained at 42-43° C.

0.4 kg of water was used to dissolve 10 g of Neutrase (Novo) before the enzyme mixture was added to the reactor. A further 2.12 kg of Cheddar cheese was then added to the reactor.

The mixture in the reactor was agitated to produce a smooth slurry and agitation reduced over the next hour. After 24 hours incubation at 42-43° C., the composition was heated to 90° C. for 15 minutes to deactivate the enzymes.

The characteristics of the final dairy product were as follows:
Moisture content: 52.7% w/w
pH: 4.2
Flavour profile: sour, strong overall impact, mildly cheesy, cultured dairy notes (e.g. sour cream, yogurt).

### EXAMPLE 4

3.9 kg of Whole milk powder (WMP) was added to 9.1 kg of water in a Starter Pot and the milk composition sterilised at 90-95° C. for 90 minutes. The milk composition was then cooled to 42° C. and starter culture comprising Lactococcus lactis subsp. lactis biovar. diacetylactis added and the milk composition mixed and allowed to ferment for ˜40 hours at 42° C., until the pH level dropped to 5.1.

3.7 kg of the acidified composition was added to an EMC reactor. 4.07 kg of ground Gouda cheese was then added to the acidic composition and the mixture gently agitated. The temperature was maintained at 42-43° C.

0.4 kg of water was used to dissolve 4.3 g of Neutrase (Novo), 5.7 g Protease 2A (Amano), 7 g Flavorpro (Biocatalysts) before the enzyme mixture was added to the reactor. A further 2.03 kg of Gouda cheese was then added to the reactor.

The mixture in the reactor was agitated to produce a smooth slurry and agitation reduced over the next hour as a thin free fat film developed. After 1 hour, 90 g of Hansen's Kid Lamp Lipase 57 was mixed into the free fat layer. After a further 24 hours incubation at 42-43° C., the composition was heated to 90° C. for 15 minutes to deactivate the enzymes.

The characteristics of the final dairy product were as follows:
Moisture content: 54.5% w/w
pH: 5.1

Flavour profile: Diacetyl, blue cheese, butyric, Gouda notes, combined with cultured dairy (yoghurt/sour cream), soapy, butyric and acidic.

### EXAMPLE 5

5.2 kg of buttermilk powder (BMP) was added to 7.8 litres of water in a Starter Pot and the buttermilk composition sterilised at 90-95° C. for 90 minutes. The buttermilk composition was then cooled to 42° C. and starter culture comprising Streptococcus thermophilus and Lactobacillus delbrueckii subsp. bulgaricus added and the buttermilk composition mixed and allowed to ferment for ˜40 hours at 42° C., until the pH level dropped to 4.6.

0.5 kg of the acidified composition was added to an EMC reactor. 6.2 kg of ground Hard Grating cheese was then added to the acidic composition and the mixture gently agitated. 0.1 kg of disodium phosphate was added and dissolved in the cheese slurry. The temperature was maintained at 42-43° C.

0.3 kg of water was used to dissolve 4.3 g of Neutrase (Novo), 7.2 g Protease 2A (Amano), 8.8 g Flavorpro (Biocatalysts) before the enzyme mixture was added to the reactor. A further 3.1 kg of Hard Grating cheese was then added to the reactor.

The mixture in the reactor was agitated to produce a smooth slurry and agitation reduced over the next hour as a thin free fat film developed. After 1 hour, 113 g of Hansen's Kid Lamp Lipase 57 was mixed into the free fat layer. After a further 24 hours incubation at 42-43° C., the composition was heated to 90° C. for 15 minutes to deactivate the enzymes.

The characteristics of the final dairy product were as follows:
Moisture content: 33.8% w/w
pH: 5.3

Flavour profile: sweet, cooked, mild butyric, marmite, Parmesan cheese notes, savoury, mild acid.

### EXAMPLE 6

1.3 kg of buttermilk powder (BMP) was added to 11.7 litres of water in a Starter Pot and the buttermilk composition sterilised at 90-95° C. for 90 minutes. The buttermilk composition was then cooled to 42° C. and starter culture comprising Lactobacillus helviticus added and the buttermilk composition mixed and allowed to ferment for 16 hours at 42° C., until the pH level dropped to 3.4.

8.1 kg of the acidified composition was added to an EMC reactor. 1.33 kg of ground Hard Grating cheese was then added to the acidic composition and the mixture gently agitated. The temperature was maintained at 42-43° C.

0.4 kg of water was used to dissolve 7 g of Palatase (Novo)—a lipase enzyme before the enzyme was added to the reactor. A further 0.5 kg of acidified composition was added to the reactor, along with a further 0.67 kg of Hard Grating cheese.

The mixture in the reactor was agitated to produce a smooth slurry and agitation reduced over the next hour. After 24 hours incubation at 42-43° C., the composition was heated to 90° C. for 15 minutes to deactivate the enzymes.

The characteristics of the final dairy product were as follows:
Moisture content: 81.6%
pH: 3.6
Flavour profile: Acid, astringent, butyric, intense impact of flavour.

### EXAMPLE 7

3.9 kg of Milk Protein Concentrate (MPC) powder (ALAPRO™ 4700 by Fonterra™) was added to 9.1 kg of water in a Starter Pot and the milk composition sterilised at 90-95° C. for 90 minutes. The milk composition was then cooled to 42° C. and starter culture comprising Lactococcus lactis subsp. lactis 1404 added and the milk composition mixed and allowed to ferment for 24 hours at 42° C., until the pH level dropped to 5.0.

5.7 kg of the acidified composition was added to an EMC reactor. 4.13 kg of ground Gouda cheese was then added to the acidic composition and the mixture gently agitated. The temperature was maintained at 42-43° C.

0.4 kg of water was used to dissolve 3.4 g of Neutrase (Novo), 4.6 g Protease 2A (Amano), 5.6 g Flavorpro (Biocatalysts) before the enzyme mixture was added to the reactor. A further 1.27 kg of Gouda cheese was then added to the reactor.

The mixture in the reactor was agitated to produce a smooth slurry and agitation reduced over the next hour as a thin free fat film developed. After 1 hour, 72 g of Hansen's Kid Lamp Lipase 57 was mixed into the free fat layer. After a further 24 hours incubation at 42-43° C., the composition was heated to 90° C. for 15 minutes to deactivate the enzymes.

The characteristics of the final dairy product were as follows:
Moisture content: 54.6
pH: 5.1

Flavour profile: Sharp acid flavour, butyric, sweet, Parmesan notes, cheesy background, some bitterness.

### EXAMPLE 8

1.3 kg of Milk Protein Concentrate (MPC) powder (ALAPRO™ 4700 by Fonterra™) was added to 11.7 kg of water in a Starter Pot and the milk composition sterilised at 90-95° C. for 90 minutes. The milk composition was then cooled to 42° C. and starter culture comprising Lactococcus lactis subsp. lactis biovar. diacetylactis added and the milk composition mixed and allowed to ferment for ˜24 hours at 42° C., until the pH level dropped to 4.8.

5.75 kg of the acidified composition was added to an EMC reactor. 2.53 kg of ground Cheddar cheese was then added to the acidic composition and the mixture gently agitated. The temperature was maintained at 42-43° C.

0.4 kg of water was used to dissolve 2.6 g of Neutrase (Novo), 3.4 g Protease 2A (Amano), 4.2 g Flavorpro (Biocatalysts) before the enzyme mixture was added to the reactor. A further 2.07 kg of Gouda cheese was then added to the reactor.

The mixture in the reactor was agitated to produce a smooth slurry and agitation reduced. After 24 hours incubation at 42-43° C., the composition was heated to 90° C. for 15 minutes to deactivate the enzymes.

The characteristics of the final dairy product were as follows:
Moisture content: 68.7%
pH: 4.8
Flavour profile: Some cheesy notes, intense, bitter, butyric flavour, harsh.

### EXAMPLE 9

5.2 kg of skim milk powder (SMP) was added to 7.8 kg of water in a Starter Pot and the milk composition sterilised at 90-95° C. for 90 minutes. The milk composition was then cooled to 42° C. and starter culture comprising Streptococcus thermophilus and Lactobacillus delbrueckii subsp. bulgaricus added and the milk composition mixed and allowed to ferment for 24 hours at 42° C., until the pH level dropped to 5.0

5.5 kg of the acidified composition was added to an EMC reactor. 2.13 kg of ground Cheddar cheese was then added to the acidic composition and the mixture gently agitated. The temperature was maintained at 42-43° C.

0.4 kg of water was used to dissolve 3.9 g of Neutrase (Novo), 5.1 g Protease 2A (Amano), 6.3 g Flavorpro (Biocatalysts) before the enzyme mixture was added to the reactor. A further 1.07 kg of Gouda cheese was then added to the reactor.

The mixture in the reactor was agitated to produce a smooth slurry and agitation reduced. After 24 hours incubation at 42-43° C., the composition was heated to 90° C. for 15 minutes to deactivate the enzymes.

The characteristics of the final dairy product were as follows:
Moisture content: 55.8
pH: 5.1
Flavour profile: Sweet, cooked, slightly burnt, marmite, Parmesan cheese,

### EXAMPLE 10

1.3 kg of skim milk powder (SMP) was added to 11.7 litres of water in a Starter Pot and the milk composition sterilised at 90-95° C. for 90 minutes. The milk composition was then cooled to 42° C. and starter culture comprising Lactobacillus helviticus added and the milk composition mixed and allowed to ferment for 16 hours at 42° C., until the pH level dropped to below 4.0.

945 g of anhydrous milk fat was placed into a twin screw process cheese cooker with a capacity of 5 kg (Blentech Corporation, Rohnert Park, Calif.) that had been pre-heated to 100° C. This was blended for 1 minute. 1113 g of MPC 70 (marketed as ALAPRO™ 4700 by Fonterra™), 89 g of Disodium phosphate and 63 g of NaCl were added to the cooker and blended for 7 minutes. At this point the blend had reached 53° C. 1295 g of acidified milk solution and 705 g of flavour ingredient as detailed in example 3 were added and mixed with culinary steam until the temperature reached 85° C. After the steam was turned off, the product was mixed for 2 minutes. The hot product was glossy, flowable and smooth coming out of the cooker. When packed into containers it was chilled to set. The final product was soft, with a smooth texture—like a firm processed cheese spread. Texture was smooth and slightly sticky in the mouth. The flavour was sweet, mild intensity, salty, cheesy, some savoury/marmite notes, very pleasant. The flavoured dairy product has a moisture level of 44.4%, a protein to water ratio of 0.52, pH of 5.6 and fat content of about 24%.

### EXAMPLE 11

945 g of anhydrous milk fat was placed into a twin screw process cheese cooker with a capacity of 5 kg (Blentech Corporation, Rohnert Park, Calif.) that had been pre-heated to 100° C. This was blended for 1 minute. 1220 g of MPC 70 (marketed as ALAPRO™ 4700 by Fonterra™), 97 g of Disodium phosphate and 63 g of NaCl were added to the cooker and blended for 6 minutes. At this point the blend had reached 53° C. 1179 g of cold water and 705 g of flavour ingredient as detailed in example 3 were added and mixed with culinary steam until the temperature reached 85° C. After the steam was turned off, the product was mixed for 2 minutes. The hot product was glossy, flowable and smooth coming out of the cooker. When packed into containers it was chilled to set. The final product was glossy looking, with a firm texture—approximately that of Gouda cheese or a processed cheese block. The flavour was pleasant, with mild cheesy notes, some sweetness and savoury notes. The flavoured dairy product has a moisture level of 43.6%, a protein to water ratio of 0.53, pH of 6.0 and fat content about 24%.

### INDUSTRIAL APPLICATION

The process of the present invention and the dairy flavour ingredient made using the process has commercial application in the dairy industry, particularly in the cheese industry. In addition, the flavour ingredient may be used to flavour savoury food in the wider food industry.

It is not the intention to limit the scope of the invention to the abovementioned examples only. As would be appreciated by a skilled person in the art, many variations are possible without departing from the scope of the invention, as defined in the accompanying claims.

1. A process for producing a dairy flavour ingredient comprising the steps:
(a) incubating a dairy based protein composition having a solids content of 10-40% w/w with acid producing bacteria under conditions to reduce the pH of the composition to below 5.5;
(b) adding ground cheese to the acidified composition of (a) in an amount to give a solids content of 20-70% w/w and blending to a slurry;
(c) incubating the slurry of (b) with at least one enzyme selected from the group consisting of proteases, peptidases and lipases, under conditions to achieve a desired flavour intensity and/or flavour profile, to produce a dairy flavour ingredient;
(d) heating the dairy flavour ingredient of (c) to inactivate the enzyme; and
(e) optionally drying the dairy flavour ingredient of (d).

2. A process as claimed in claim 1, wherein the dairy based protein composition is selected from the group consisting of a milk or milk product selected from one or more of the group consisting of pasteurised or unpasteurised whole milk, skim milk, reduced fat milk, fat enhanced milk, butter milk, milk ultrafiltrate retentates, milk concentrates or isolates, reconstituted powdered milks including powdered whole, reduced fat or skim milk and powdered butter milk, wherein the milk or milk product is sourced from any milk producing animal or analogue milk, or a combination thereof.

3. A process as claimed in claim 1, wherein the dairy based protein composition is selected from the group consisting of reconstituted milk protein concentrate (MPC), skim milk powder (SMP), butter milk powder (BMP) and whole milk powder (WMP), or a combination thereof.

4. A process as claimed in claim 1, wherein salt and/or additional GRAS ingredients are added to the dairy based protein composition of step (a), and/or to the slurry of step (b) or step (c).

5. A process as claimed in claim 1, wherein the acid producing bacteria added in step (a) comprise at least one mesophilic or thermophilic starter culture or a combination thereof, added at a concentration of 0.1-6.0% w/w of the composition.

6. A process as claimed in claim 5, wherein the at least one starter culture is selected from the group consisting of Streptococcus thermophilus, Lactobacillus bulgaricus, Lactobacillus helveticus, Lactobacillus lactis subspecies cremoris, Lactobacillus lactis subspecies lactis, Lactococcus lactis subspecies lactis biovar, diacetylactis and Lactobacillus delbrueckii subspecies bulgaricus.

7. A process as claimed in claim 1, wherein in step (a) the pH of the composition is reduced to below 5.0.

8. A process as claimed in claim 1, wherein in step (a) the pH of the composition is reduced to below 3.0 and 4.0.

9. A process as claimed in claim 1, wherein in step (b) sufficient ground cheese is added to give a solids content of 40-60% w/w.

10. A process as claimed in claim 1, wherein in step (c) the at least one enzyme is selected from the group consisting of Protease 2A, Neutrase, Flavorpro, Promod, Savorase, Accelase, Palata+se, Kid Lamb Lipase 57, and any other commercially available enzyme.

11. A process as claimed in claim 1, wherein the incubation step (c) is carried out at 20-60° C. for 2 to 48 hours.

12. A process as claimed in claim 11, wherein the incubation step (c) is carried out at 4050° C. for 10-30 hours.

13. A process as claimed in claim 1, wherein the dairy flavour ingredient of step (c) has a moisture content of 30-80% w/w.

14. A process as claimed in claim 13, wherein the dairy flavour ingredient of step (c) has a moisture content of 30-60% w/w.

15. A process as claimed in claim 1, wherein step (d) is carried out at 80-100° C. for 3 to 30 minutes.

16. A process as claimed in claim 15, wherein step (d) is carried out at 90° C. for 15 minutes.

17. A dairy flavour ingredient produced by the process of claim 1.

18. A dairy food product which has been flavoured by the dairy ingredient of claim 17.

19. A dairy food product as claimed in claim 18, selected from the group consisting of a natural cheese, including a natural hard, semi-soft or soft cheese, an analogue cheese, foods comprising natural or analogue cheese, processed cheese, yoghurt, mousse, dessert, dairy dip and dressing.

20. A dairy product as claimed in claim 19, comprising a natural cheese or cheese-like product selected from the group consisting of Cheddar or Cheddar-like cheese, Parmesan or Parmesan-like cheese, Gouda or Gouda-like cheese, Edam or Edam-like cheese and any other hard cheese in solid block or crumble form.

21. A dairy food product as claimed in claim 18, wherein said product is produced by conventional or rapid dairy processes.

22. A dairy flavour ingredient comprising a moisture content of 30-80% w/w, a solids content of 20-70% w/wand a pH of less than 5.5.

23. A dairy flavour ingredient as claimed in claim 22, comprising a moisture content of 3060% w/w, a solids content of 40-60% w/w and a pH of less than 5.0.

24. A dairy flavour ingredient as claimed in claim 22, wherein the pH is between 3.0 and 4.0.

25. A flavoured dairy product comprising the diary flavour ingredient of claim 22.

26. The flavoured dairy product of claim 25, wherein the flavoured dairy product is selected from the group consisting of a natural cheese, including a natural hard, semi-soft or soft cheese, an analogue cheese, foods comprising natural or analogue cheese, yoghurt, mousse, dessert, dairy dip and dressing.

27. The flavoured dairy product of claim 26, wherein the flavoured dairy product is a cheese or cheese-like product selected from the group consisting of Cheddar, Cheddar-like cheese, Parmesan, Parmesan-like cheese, Edam, Edam-like cheese, Gouda, Gouda-like cheese and any other hard cheese in a solid block or crumble form.

28. A process for producing a flavoured dairy product comprising the steps:
(a) providing a dairy based protein composition comprising a milk or milk product selected from one or more of the group consisting of pasteurised or unpasteurised whole milk, skim milk, reduced fat milk, fat enhanced milk, butter milk, milk ultrafiltrate retentates, milk concentrates or isolates, reconstituted powdered milks including powdered whole, reduced fat or skim milk and powdered butter milk, wherein the milk or milk product is sourced from any milk producing animal or analogue milk, or a combination thereof; and
(b) cooking to form a dairy product;
wherein a dairy flavour ingredient of claim 22 is added either before or during the cooking step to produce a flavoured dairy product having a desired flavour profile.

29. A flavoured dairy product made by the process of claim 28.

30. A flavoured dairy product as claimed in claim 29, selected from the group consisting of a natural hard, semi-soft or soft cheese, an analogue cheese, foods comprising natural or analogue cheese, yoghurt, mousse, dessert, dairy dip and dressing.

31. A flavoured dairy product as claimed in claim 30, comprising a natural cheese or cheese-like product selected from the group consisting of Cheddar or Cheddar-like cheese, Parmesan or Parmesan-like cheese, Gouda or Gouda-like cheese, Edam or Edam-like cheese and any other hard cheese in solid block or crumble form.
